(19) United States
(12) Patent Application Publication
(10) Pub. No.: US 2026/0036329 A1
(43) Pub. Date: Feb. 5, 2026

(54) LOUVER ASSEMBLY

(71) Applicant: Air Distribution Technologies, IP LLC, Plano, TX (US)

(72) Inventor: Park A. Wood, Raytown, MO (US)

(21) Appl. No.: 19/286,909

(22) Filed: Jul. 31, 2025

Related U.S. Application Data
(60) Provisional application No. 63/677,908, filed on Jul. 31, 2024.

(51) Int. Cl. F24F 13/14; E06B 1/70; E06B 7/08; E06B 7/14

(52) U.S. Cl. CPC F24F 13/14; E06B 1/70; E06B 7/08; E06B 7/14

(57) ABSTRACT

The present disclosure discloses a louver assembly including a head frame and a sill frame. At least one of the head frame and the sill frame has a channel to drain water. According to another aspect, the louver assembly includes a head frame having a first blade attachment and a sill frame having a second blade attachment. At least one of the first blade attachment and the second blade attachment is configured to connect to one or more blades via welding or fastening means.

### CROSS-REFERENCE TO RELATED APPLICATIONS

The present application claims priority to U.S. Provisional Patent Application No. 63/677,908, filed Jul. 31, 2024, the entire contents of which is incorporated by reference herein.

### BACKGROUND

The present disclosure relates generally to louvers for HVAC systems.

A louver is typically employed to allow air therethrough, and simultaneously, prevent ingress of solid and/or liquid particles through the louver. The louver can be installed at any suitable location. For example, a louver can be installed in a window of a building, wherein the louver allows airflow into the building and prevent ingress of foreign particles.

### SUMMARY

The present disclosure discloses a louver including a head frame and a sill frame. At least one of the head frame and the sill frame has a channel to drain water.

In some embodiments, the channel in the head frame is in fluid communication with at least one of jambs of the louver to drain water accumulated in the head frame.

In some embodiments, the louver has a pocket for concealing fasteners that connect blades to the sill frame, and the channel in the sill frame is in fluid communication with the pocket.

According to another aspect of the present disclosure, the louver includes a head frame having a first blade attachment and a sill frame having a second blade attachment. At least one of the first blade attachment and the second blade attachment is configured to connect to one or more blades via welding or fastening means.

The present disclosure provides, in one aspect, a vertical louver assembly including a head frame, a sill frame, and a channel formed in at least one of the head frame and the sill frame, the channel configured to drain water out of the louver assembly.

The present disclosure provides, in another aspect, a vertical louver assembly including a head frame, a sill frame, a first blade attachment coupled to the head frame, a second blade attachment coupled to the sill frame, and a channel formed in at least one of the head frame and the sill frame, the channel configured to drain water out of the louver assembly.

The present disclosure provides, in another aspect, a vertical louver including a head frame having a first blade attachment, a sill frame having a second blade attachment, and at least one of the first blade attachment and the second blade attachment configured to connect to one or more blades via welding or fastening means.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a perspective view of an embodiment of a building that may utilize a heating, ventilation, and/or air conditioning (HVAC) system, in accordance with an aspect of the present disclosure.

FIG. 2 is a perspective view of an exemplary louver assembly according to some embodiments.

FIG. 3 is a cross-sectional view of the louver assembly of FIG. 2 taken along the line 3-3.

FIG. 4 is a cross-sectional view of a head frame of the louver assembly, according to some embodiments of the present disclosure.

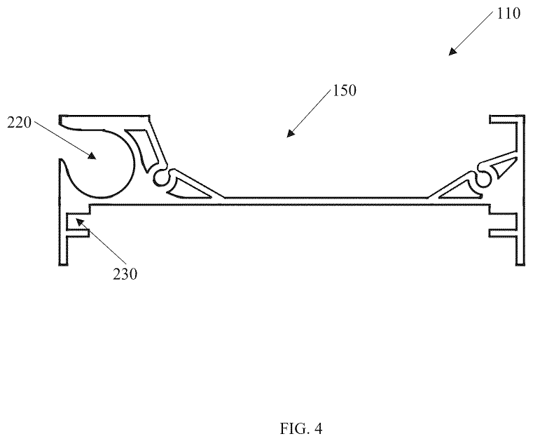

FIG. 5 is a cross-sectional view of a sill frame of the louver assembly, according to some embodiments of the present disclosure.

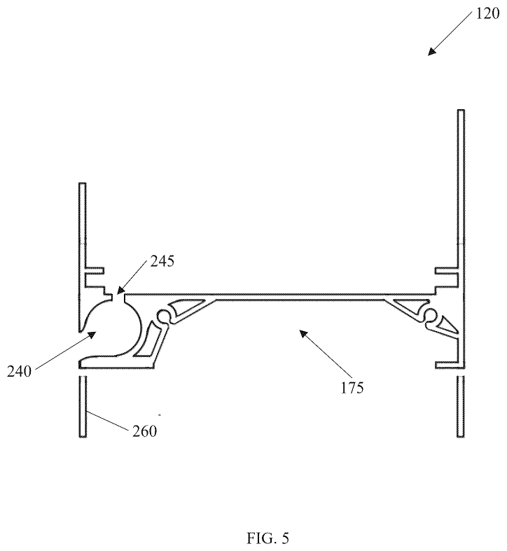

FIG. 6 is an isometric view of a blade attachment of the louver assembly, according to some embodiments of the present disclosure.

FIG. 7 is a cross-sectional view depicting the blade attachment and connection thereof with blades of the louver assembly, according to some embodiments of the present disclosure.

FIG. 8 is a schematic view depicting the blades of the louver assembly, according to some embodiments of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

### Building HVAC System

As briefly discussed above, a heating, ventilation, and/or air conditioning (HVAC) system may be used to thermally regulate a space within a building, home, or other suitable structure. The HVAC system may include an HVAC unit configured to condition an air flow via an evaporator, a furnace, a heating coil, a chiller system, other components, or a combination thereof, and to provide the conditioned air flow (e.g., a heated air flow, a cooled air flow, a dehumidified air flow) to the space. For example, the HVAC unit may be fluidly coupled to the space via an air distribution system, such as a system of ductwork, which extends between the HVAC unit and the space. As such, one or more fans or blowers of the HVAC system may be operable to direct a supply of conditioned air from the HVAC unit, through the ductwork, and into the spaces within the building.

Typically, the HVAC system includes one or more dampers that are disposed within the ductwork and are configured to regulate fluid flow along the ductwork. For example, the dampers may include adjustable dampers that are set to particular positions (e.g., manually, via an actuator of the dampers) to achieve a desired flow rate of conditioned air to the room, zone, or other space serviced by the dampers. In some embodiments, the dampers can include fire dampers that are configured to transition to a closed configuration to block fluid flow (e.g., air, smoke) along the ductwork in response to a temperature within or near the ductwork exceeding or approaching a threshold value.

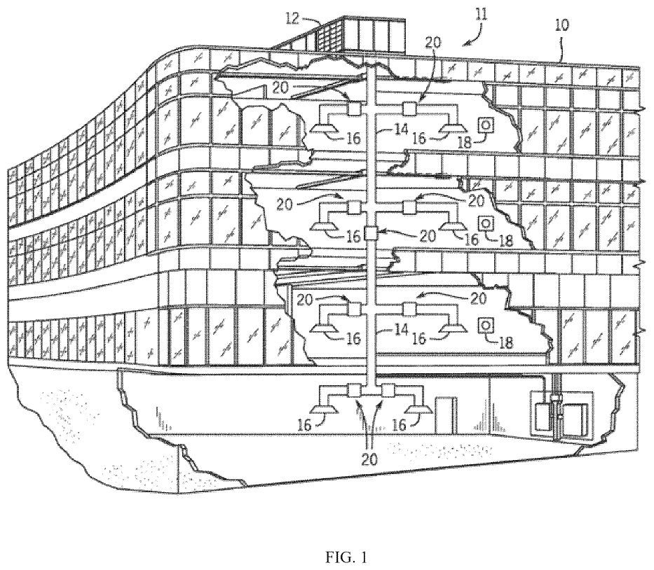

Turning now to the drawings, FIG. 1 illustrates an embodiment of a heating, ventilation, and/or air conditioning (HVAC) system for environmental management that may employ one or more HVAC units. As used herein, an HVAC system includes any number of components configured to enable regulation of parameters related to climate characteristics, such as temperature, humidity, air flow, pressure, air quality, and so forth. For example, an “HVAC system” as used herein is defined as conventionally understood and as further described herein. Components or parts of an “HVAC system” may include, but are not limited to, all, some of, or individual parts such as a heat exchanger, a heater, an air flow control device, such as a fan, a sensor configured to detect a climate characteristic or operating parameter, a filter, a control device configured to regulate operation of an HVAC system component, a component configured to enable regulation of climate characteristics, or a combination thereof. An “HVAC system” is a system configured to provide such functions as heating, cooling, ventilation, dehumidification, pressurization, refrigeration, filtration, or any combination thereof. The embodiments described herein may be utilized in a variety of applications to control climate characteristics, such as residential, commercial, industrial, transportation, or other applications where climate control is desired.

In the illustrated embodiment, a building 10 is air conditioned by an HVAC system 11 having an HVAC unit 12. The building 10 may be a commercial structure or a residential structure. As shown, the HVAC unit 12 is disposed on the roof of the building 10; however, the HVAC unit 12 may be located in other equipment rooms or areas adjacent the building 10. The HVAC unit 12 may be a single package unit containing other equipment, such as a blower, integrated air handler, and/or auxiliary heating unit. In other embodiments, the HVAC unit 12 may be part of a split HVAC system, which includes an outdoor HVAC unit and an indoor HVAC unit.

The HVAC unit 12 is an air-cooled device that implements a refrigeration cycle to provide conditioned air to the building 10. Specifically, the HVAC unit 12 may include one or more heat exchangers across which an air flow is passed to condition the air flow before the air flow is supplied to the building 10. In the illustrated embodiment, the HVAC unit 12 is a rooftop unit (RTU) that conditions a supply air stream, such as environmental air and/or a return air flow from the building 10. The HVAC unit 12 may provide a variety of heating and/or cooling functions, such as cooling only, heating only, cooling with electric heat, cooling with dehumidification, cooling with gas heat, or cooling with a heat pump. For example, in certain embodiments, the HVAC unit 12 may be a heat pump that provides both heating and cooling to the building with one refrigeration circuit configured to operate in different modes. In other embodiments, the HVAC unit 12 may include one or more refrigeration circuits for cooling an air stream and a furnace for heating the air stream.

In any case, after the HVAC unit 12 conditions the air, the air may be supplied to the building 10 via ductwork 14 extending from the HVAC unit 12 and throughout the building 10. For example, the ductwork 14 may extend to various individual floors, rooms zones, or other sections or spaces of the building 10. In some embodiments, a plurality of diffuser assemblies 16 are coupled to the ductwork 14. The diffuser assemblies 16 may direct the conditioned air received from the ductwork 14 into the various spaces of the building 10 in a manner that improves air distribution and/or air dispersion across the spaces.

In some embodiments, a control device 18, one type of which may be a thermostat, may be used to designate the temperature of the conditioned air supplied by the HVAC unit 12. The control device 18 also may be used to control the flow of air through the ductwork 14. For example, the control device 18 may be used to regulate operation of one or more components of the HVAC unit 12 or other components, such as dampers and fans, within the building 10 that may control flow of air through and/or from the ductwork 14. In some embodiments, other devices may be included in the system, such as pressure and/or temperature transducers or switches that sense the temperatures and pressures of supply air, return air, and so forth. Moreover, the control device 18 may include computer systems that are integrated with or separate from other building control or monitoring systems, and even systems that are remote from the building 10.

In the illustrated embodiment, the HVAC system 11 includes a plurality of damper assemblies 20 (e.g., dampers) that are coupled to the ductwork 14 and/or form a portion of the ductwork 14 and are configured to regulate fluid flow through the ductwork 14. For example, the damper assemblies 20 may include one or more dampers configured to regulate distribution of a flow of conditioned air generated by the HVAC unit 12 to one or more rooms, zones, or other spaces within the building 10.

### Louver Assembly

The present disclosure discloses a vertical louver assembly. The louver assembly may include a head frame, a sill frame and jambs. Preferably, the head frame and the sill frame support a plurality of vertical blades. The louver assembly is exposed to high-speed airflow and storm conditions. Generally, during storm conditions, airflow may carry water particles into the louver assembly. The louver assembly, of the present disclosure, includes a channel provided with at least one of the head frame and the sill frame to drain water. In some embodiments, the channel may be provided with the head frame or the sill frame. In some embodiments, the channel may be provided with both the head frame and the sill frame.

The channel in the head frame may be connected to one or both jambs of the louver assembly for carrying water accumulated in the head frame to the jamb frame. The jambs may be provided with suitable gutters for carrying water to the sill frame for draining out of the louver assembly.

The channels of the head frame and the sill frame may have suitable shape and dimensions. In some embodiments, the channels of the head frame and the sill frame may extend along the width of the louver, i.e. along direction of the airflow. In some other embodiments, the channels of the head frame and the sill frame may extend from a front side of the louver assembly up to certain width of the louver.

The channels of the head frame and the sill frame may have any suitable shape and size. In some embodiments, the channels of the head frame and sill frame may have an arcuate shape defining a space for collecting water.

The louver assembly may have pockets at the head frame and sill frame for concealing fasteners that attach blades to the head and sill frame. In some embodiments, the channel of the head frame is configured above the pocket of the head frame. In some other embodiments, the channel in the sill frame is configured below the pocket of the sill frame. Further, the channel in the sill frame is in fluid communication with the pocket of the sill frame to drain out water accumulated in the pocket of the sill frame.

In accordance with another aspect, the louver assembly may include blade attachment means configured to facilitate attachment of the blades with the head or sill frame by welding or via fastening means. The head frame may include a first blade attachment. The sill frame may include a second blade attachment. At least one of the first blade attachment and the second blade attachment is configured to connect to one or more blades via welding or fastening means. Thus, the blades can be connected in either way (welding or fastening) with the blade attachment. In case of a fastened blade detaches from the blade attachment, detached blade can be welded to the blade attachment. Similarly, if welded blade detaches, detached blade can be fastened to the blade attachment as the blade attachment has provisions for both fastening and welding.

In some embodiments, screw bosses may be provided on the blades for receiving fasteners. Further, appropriate provision (for example, notches) may be provided on the blade attachment for welding the blades with the blade attachment.

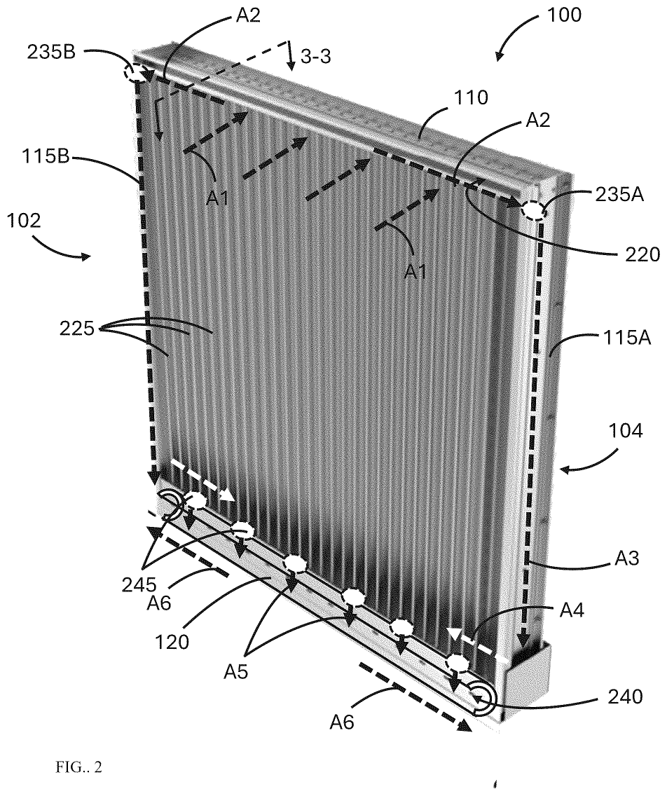

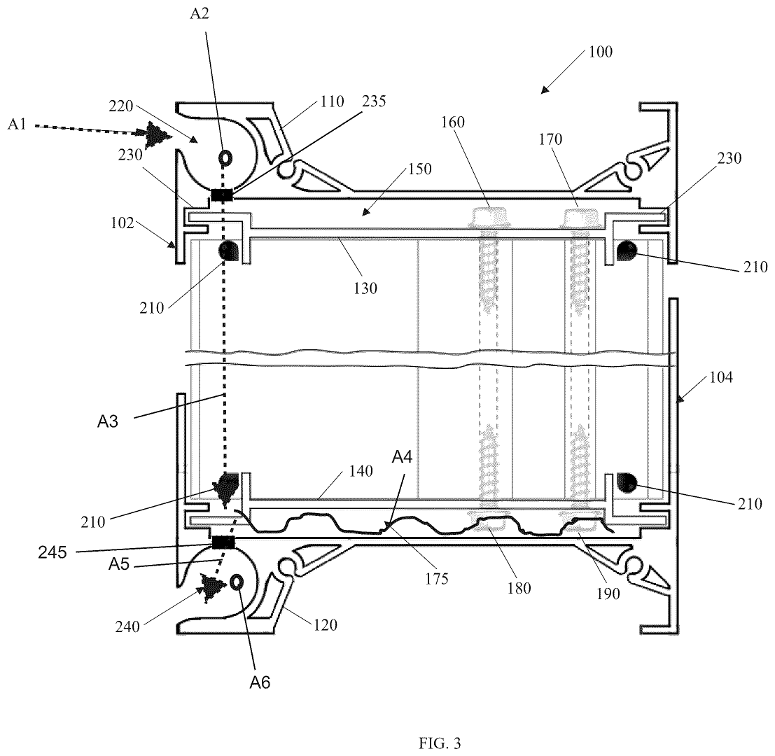

FIG. 2 provides a perspective view of an exemplary louver assembly 100 in accordance with one embodiment of the disclosure. FIG. 3 provides a cross-sectional view of a louver assembly 100 in accordance with one embodiment of the disclosure. The louver assembly 100 includes a head frame 110, a sill frame 120, jambs 115, a plurality of blades 125, a first blade attachment 130, and a second blade attachment 140. The head frame 110 and the sill frame 120 extend between the jambs 115 (i.e., left to right in FIG. 2). The head frame 110 and the sill frame 120 also extend between a front side 102 and a rear side 104 of the louver assembly 100. In an operative configuration, the front side 102 faces the airflow external to the building. The plurality of blades 125 extend between the head frame 110 and the sill frame 120 and are supported by the first blade attachment 130 and the second blade attachment 140.

Preferably, the first blade attachment 130 is secured to the head frame 110. The head frame 110 may have notches 230 for securing the first blade attachment 130. Further, a first pocket 150 may be defined between the head frame 110 and the first blade attachment 130 to conceal fasteners 160, 170. Further, the second blade attachment 140 is secured to the sill frame 120. The sill frame 120 may have notches for securing the second blade attachment 140. A second pocket 175 may be defined between the sill frame 120 and the second blade attachment 140 to conceal fasteners 180, 190.

The blade attachments 130, 140 may have provision(s) for welding, as will be described in greater detail below. In one example, the blade attachments 130, 140 can be attached to other components of the louver assembly 100 via welding at locations 210.

Referring to FIGS. 2 and 3, the head frame 110 is shown to include a first channel 220 to receive water. Preferably, the first channel 220 is configured to receive water cascading from above the louver assembly 100. The first channel 220 may have any suitable size and shape. In some embodiments, the first channel 220 has an arcuate shape to store water. The first channel 220 is open to the front side 102 of the louver assembly 100 to receive water at an entry point depicted by arrows A1. Further, the first channel 220 is in fluid communication with one or more jambs 115 of the louver assembly 100 to carry water accumulated in the first channel 220 to the jambs 115. Water entering the louver assembly 100 via the first channel 220 may then flow along the flow path depicted by arrows A2. Water flowing along the first channel 220 may either flow in a first direction towards a first jamb 115A or may flow in a second direction towards a second jamb 115B. Water may exit the first channel 220 via drain holes 235A, 235B (generally 235) on each side of the channel 220, which are located adjacent to the first jamb 115A and the second jamb 11B, respectively.

The jambs 115 then deliver water from the head frame 110 to the sill frame 120, which will eventually drain out from the front side 102 of the louver assembly 100. In other words, the second channel 240 in the sill frame 120 is configured to receive water from the jambs 115 and drain the water out of the louver assembly 100. Water flows downward along a flow path depicted by arrows A3 from the head frame 110 to the sill frame 120 via gutters in the jambs 115.

With continued reference to FIGS. 2 and 3, the sill frame 120 is shown to include a second channel 240 to receive water from the jambs 115. In some embodiments, the second channel 240 may receive water which accumulates in the second pocket 175. In this embodiment, the water may flow into the pocket 175 along a path shown by arrows A4. This water may accumulate in the pocket 175 until it is drained into the second channel 240. A passage 245 may be provided between the second channel 240 and the second pocket 175 to channelize water in the second pocket 175 to the second channel 240. In this embodiment, the water may enter the second channel 240 along a flow path identified by arrows A5. Furthermore, in some embodiments, the louver assembly 100 may include a single passage 245, such as a single hole or a long slit, while in other embodiments, the louver assembly 100 may include a plurality of passages 245, such as a multiple holes or slits).

Accordingly, the head frame 110 may be provided with drain holes 235 proximate the jambs 115 to channelize water from the first channel 220 to jambs 115. Similarly, the sill frame 120 may be provided with drain holes 245 to channelize water further to the second channel 240.

Water routed into the second channel 240 may then flow out of the louver assembly 100, thereby being prevented from entering the building or the space between the blades 225. In some embodiments, the water may flow along the second channel 240 in the direction illustrated by arrows A6.

Referring to FIG. 3, the shape of the second channel 240 may be designed to create a low-pressure void, which will allow water to flow out of the louver assembly 100 in the presence of high velocity winds. In some instances, drain holes may be provided on a front facing surface of the sill frame 120 to allow water to exit the louver assembly. This arrangement may work well in areas without high winds or high velocity air flow external to the louver assembly 100. However, in the presence of high velocity winds, the winds create a blockage in front of the drain holes, thereby preventing the water from exiting the louver assembly 100. Similarly, the wind may spray the water back towards the front 102 of the louver assembly 100 and into the blades 225. Accordingly, in areas with high velocity winds, a c-shaped second channel 240 (i.e., c-shaped cross-section) may be used to avoid these issues. In the event of high velocity wind, the shape of the second channel 240 creates a low-pressure void to pull the water out of the second channel 240. The wind may create a vortex effect in the second channel, which may increase the flow of the water along the path A6 of the second channel 240.

Similarly, the first channel 220 may also be shaped with a c-shaped cross-section to create a similar effect on the water in the first channel 220. It should be noted that others shapes may be used to create the low-pressure void which aids in the flow of water within the channels 220, 240. Further, it should be noted that the drain holes 235 in the head frame 110 and the drain holes 245 in the sill frame are protected from the airflow due to their position within the louver assembly 100.

The flow path of the water will now be described wholistically. Water enters the front side 102 of the louver assembly 100 via the first channel 220, as depicted by arrows A1. The first channel 200 then delivers water to the jambs 115. The first channel 200 allows water to flow in either a first direction towards the first jamb 115A or a second direction towards the second jamb 115B, as depicted by arrows A2. The water then drains through drain holes 235A and 235B in the head joint 110 into the jambs 115A and 115B. Gutters in the jambs 115 allow the water to flow from the head frame 110 to the sill frame 120 along the path identified by arrows A3. In some embodiments, the water may enter the sill frame 120 and accumulate in a pocket 175 above the sill frame 120 in the arear identified by arrow A5. The sill frame 120 may include a one or more passage 245 leading from the pocket 175 to the channel 240 along the path identified by arrows A5. Finally, water exits the louver assembly 100 by flowing out of the second channel 240 along the flow path identified by arrows A6.

Further, the sill frame 120 may be optionally provided with front/rear flanges or glazing frame attachments 260. The head frame 110 and the sill frame 120 can be used with either a standard H-channel or U-channel notched Jamb 115 frame. It can be welded and/or mechanically fastened and sealed with caulking.

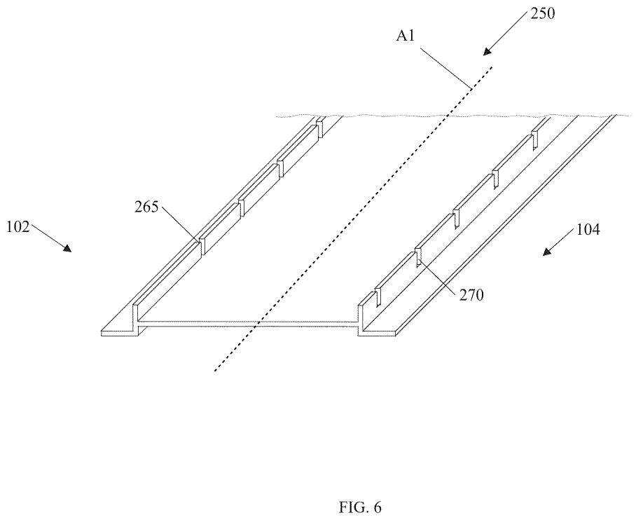

FIG. 6 illustrates one embodiment of a blade attachment 250 (for example, the first blade attachment 130 or the second blade attachment 140). The blade attachment 250 includes a plurality of notches 265, 270 to receive a portion of blades of the louver assembly 100. For example, the blade attachment 250 includes front blade notches 265 and rear blade notches 270 to receive front portion and rear portion of the blades respectively.

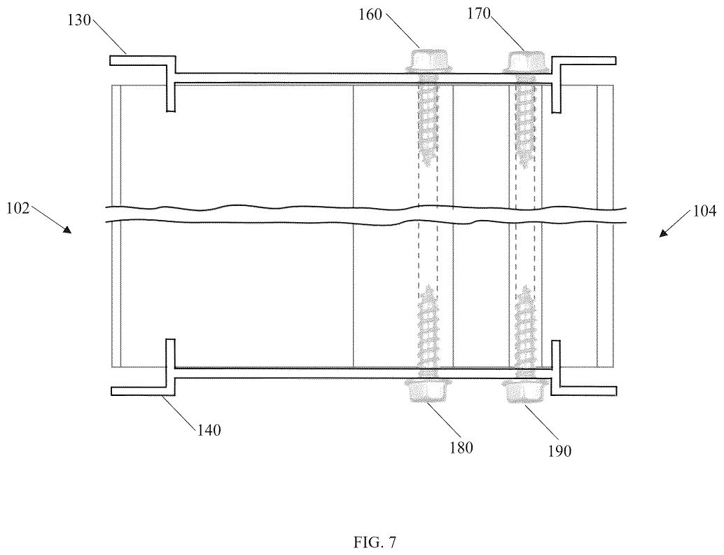

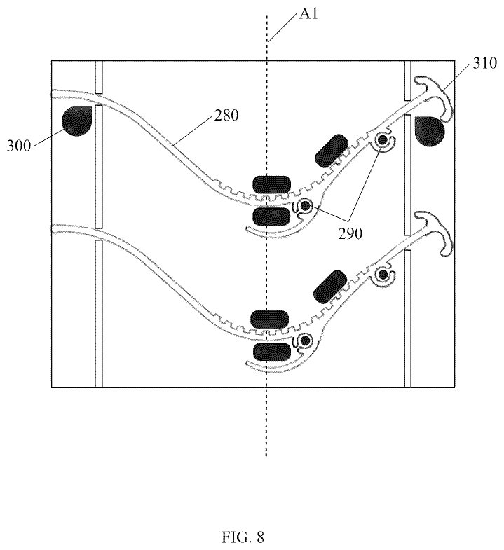

Referring to FIG. 7 and FIG. 8, mounting of blades 280 in the louver assembly 100 is now elaborated. The blades 280 may be welded to the blade attachments 130, 140, secured to the blade attachments 130, 140 via fasteners, or a combination of welding and fasteners. The blade attachments 130, 140 are configured to facilitate both welding and fastening attachment with the blades 280. The blade attachments 130, 140 may have punched holes that align with screw bosses 290 on the blades 280. The fasteners 160-190 may be passed through the punched holes on the blade attachments 130, 140 and the screw bosses 290. Although, accompanying figures show that the blades 280 are secured to the blade attachments 130, 140 at two locations, the present disclosure is not limited to fastening the blades 280 at two locations, and the blades 280 can be secured to the blade attachments 130, 140 at one or more than two locations in other embodiments.

The blades 280 can be welded to the blade attachments 130, 140. FIG. 8 shows examples of locations 300 at which the blades 280 can be welded to the blade attachments 130, 140.

In some embodiments, the blades 280 are secured to the blade attachments 130, 140 to form the core of the louver assembly 100. Further, the core is secured to the head frame 110 and the sill frame 120.

The blades 280 may have a profile that is combination of a mechanically fastened blade and a welded blade. For example, the blade 280 has the screw bosses 290 and a back hook 310 to catch water droplets.

Although the present disclosure is elaborated with the louver assembly having both channels and blade attachment, these features can be independently provided. For example, the louver assembly can have the channels without welding and fastening blade attachment means, and vice versa.

### CONFIGURATION OF EXEMPLARY EMBODIMENTS

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

Although the figures show a specific order of method steps, the order of the steps may differ from what is depicted. Also, two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

What is claimed is:

1. A vertical louver assembly comprising:
a head frame;
a sill frame; and
a channel formed in at least one of the head frame and the sill frame, the channel configured to drain water out of the louver assembly.

2. The assembly of claim 1, wherein the head frame includes a first channel and the sill frame includes a second channel.

3. The assembly of claim 2, wherein the first channel in the head frame is in fluid communication with a jamb of the louver and configured to carry water accumulated in the head frame to the jamb.

4. The assembly of claim 3, wherein the second channel in the sill frame is configured to receive water from the jamb to drain the water out of the louver assembly.

5. The assembly of claim 2, further comprising a first pocket defined within the head frame and a second pocket defined within the sill frame.

6. The assembly of claim 5, wherein the first channel is positioned above the first pocket, and wherein the second channel is positioned below the second channel.

7. The assembly of claim 2, wherein the second channel in the sill frame is sized and shaped to create a low-pressure void to pull water out of the second channel.

8. The assembly of claim 1, wherein the sill frame forms a pocket for concealing fasteners connecting blades to the sill frame, and wherein the channel in the sill frame is in fluid communication with the pocket via a passage formed in the sill frame.

9. The assembly of claim 1, further comprising a first blade attachment coupled to the head frame and a second blade attachment coupled to the sill frame.

10. The assembly of claim 1, wherein the channel includes a drain hole to drain water out of the channel.

11. A vertical louver assembly comprising:
a head frame;
a sill frame;
a first blade attachment coupled to the head frame;
a second blade attachment coupled to the sill frame; and
a channel formed in at least one of the head frame and the sill frame, the channel configured to drain water out of the louver assembly.

12. The assembly of claim 11, wherein the head frame includes a first channel and the sill frame includes a second channel.

13. The assembly of claim 12, wherein the first channel in the head frame is in fluid communication with a jamb of the louver and configured to carry water accumulated in the head frame to the jamb.

14. The assembly of claim 13, wherein the second channel in the sill frame is configured to receive water from the jamb to drain the water out of the louver assembly.

15. The assembly of claim 12, further comprising a first pocket defined within the head frame and a second pocket defined within the sill frame.

16. The assembly of claim 15, wherein the first channel is positioned above the first pocket, and wherein the second channel is positioned below the second channel.

17. The assembly of claim 12, wherein the second channel in the sill frame is sized and shaped to create a low-pressure void to pull water out of the second channel.

18. The assembly of claim 11, wherein the sill frame forms a pocket for concealing fasteners connecting blades to the sill frame, and wherein the channel in the sill frame is in fluid communication with the pocket via a passage formed in the sill frame.

19. The assembly of claim 11, wherein the channel includes a drain hole to drain water out of the channel.

20. A vertical louver comprising:
a head frame having a first blade attachment;
a sill frame having a second blade attachment;
a first blade coupled to the first blade attachments via a fastening means; and
a second blade coupled to the first blade attachment via welding.
